(19) United States
(12) Patent Application Publication
(10) Pub. No.: US 2026/0106082 A1
(43) Pub. Date: Apr. 16, 2026

(54) MULTILAYER ELECTRONIC COMPONENT

(71) Applicant: SAMSUNG ELECTRO-MECHANICS CO., LTD., Suwon-si (KR)

(72) Inventors: So Jung AN, Suwon-si (KR); Yoo Jeong LEE, Suwon-si (KR); Chae Min PARK, Suwon-si (KR); So Eun CHOI, Suwon-si (KR); Jung Won PARK, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/322,390

(22) Filed: Sep. 8, 2025

(30) Foreign Application Priority Data
Oct. 15, 2024 (KR) 10-2024-0139988

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/12; H01G 4/30

(57) ABSTRACT

A multilayer electronic component includes a body having a dielectric layer and internal electrodes alternately arranged with the dielectric layer in a first direction. The body further includes first and second surfaces opposing each other in the first direction, and third and fourth surfaces connected to the first and second surfaces and opposing each other in a second direction. An external electrode is provided, including a connection portion disposed on the third and fourth surfaces and a band portion extending from the connection portion to a portion of the first surface. A bump electrode is disposed on the band portion of the external electrode. A solder layer, comprising a Sn-based solder, is disposed between the band portion of the external electrode and the bump electrode. The solder layer extends across a cross-section of the bump electrode and the connection portion of the external electrode in the second direction.

### CROSS-REFERENCE TO RELATED APPLICATION(S)

This application claims the benefit of priority to Korean Patent Application No. 10-2024-0139988 filed on Oct. 15, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor MLCC, a multilayer electronic component, is an important chip component used in industries such as communications, computers, home appliances, and automobiles due to the advantages of being small in size and guaranteeing high capacitance, and in particular, is a key passive component used in various electrical, electronic, and information and communication devices such as mobile phones, computers, digital TV, or the like. In addition, as multilayer ceramic capacitors are used in automobiles and infotainment systems, demand for high reliability, high strength characteristics, and miniaturization is increasing.

Since a dielectric layer included in the multilayer ceramic capacitor has piezoelectricity and electrostriction, when a direct current (DC) or alternating current (AC) voltage is applied to the multilayer ceramic capacitor, a piezoelectric phenomenon may occur between the internal electrodes, causing vibrations.

These vibrations may be transmitted to a printed circuit board on which the multilayer ceramic capacitor is mounted through the external electrodes of the multilayer ceramic capacitor, thereby generating a vibration sound. The vibration sound may correspond to an audible frequency in a range of 20 to 20,000 Hz, which may be unpleasant for people, and such vibration sound causing unpleasantness to people may be referred to as acoustic noise.

Conventionally, as a method for reducing acoustic noise, methods such as making an upper and lower cover portions of a body different in thickness, bonding an interposer containing a ceramic material to the lower portion of a capacitor, or bonding a metal bump to the lower portion of the capacitor have been used.

In the case of a method of bonding the metal bump to the lower portion of the capacitor, a method in which an external electrode and the metal bump are bonded with high-temperature solder as in patent document 1 is known, and the substrate and electronic components may be coupled using general solder.

In products in which a metal bump is attached (where high-temperature solder exists only between the external electrode and the metal bump), a Sn plating layer providing mountability may flow downwardly due to the additional soldering process, so the thickness of an upper portion may be thinner than that of general products. As a result, when an Ni plating layer is thin or broken, acting as a path for moisture penetration, it may result in reduced reliability

### SUMMARY

An aspect of the present disclosure is to provide a multilayer electronic component having excellent reliability.

Another aspect of the present disclosure is to prevent an occurrence of mounting defects.

However, the purpose of the present disclosure is not limited to the above-described content, and may be more easily understood in the process of explaining specific embodiments of the present disclosure.

A multilayer electronic component according to an embodiment of the present disclosure may include: a body including a dielectric layer and internal electrodes alternately disposed with the dielectric layer in a first direction, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; an external electrode including a connecting portion disposed on the third and fourth surfaces and a band portion extending from the connecting portion to a portion of the first surface; a bump electrode disposed on the band portion of the external electrode; and wherein a solder layer includes a Sn-based solder containing one or more of Sb, Ag, and Cu, disposed between the band portion of the external electrode and the bump electrode, and extending to cross-section in the second direction of the bump electrode and a connection portion of the external electrode.

### BRIEF DESCRIPTION OF DRAWINGS

The above and other aspects, features, and advantages of the present disclosure will become more clearly understood from the following detailed description, taken in conjunction with the accompanying drawings, in which:

FIG. 1 is a perspective illustrating a multilayer electronic component according to an embodiment of the present disclosure.

FIG. 2 is a bottom perspective view of the multilayer electronic component according to FIG. 1.

FIG. 3 is a cross-sectional view taken along line I-I′ of FIG. 1.

FIG. 4 is a cross-sectional view taken along line II-II′ of FIG. 1.

FIG. 5 is an exploded perspective view illustrating a body of a multilayer electronic component according to one embodiment of the present disclosure.

FIG. 6 is an enlarged view of region K1 of FIG. 3.

FIG. 7 schematically illustrates a lower surface of a bump electrode.

FIG. 8 is an enlarged view of region K1 of FIG. 3 according to another embodiment of the present disclosure.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use the same reference numerals. Throughout the specification, when a component is referred to as “comprise” or “comprising,” it means that it may further include other components as well, rather than excluding other components, unless specifically stated otherwise.

In the drawings, a first direction may refer to a thickness T direction, a second direction may refer to a length L direction, and a third direction may refer to a width W direction.

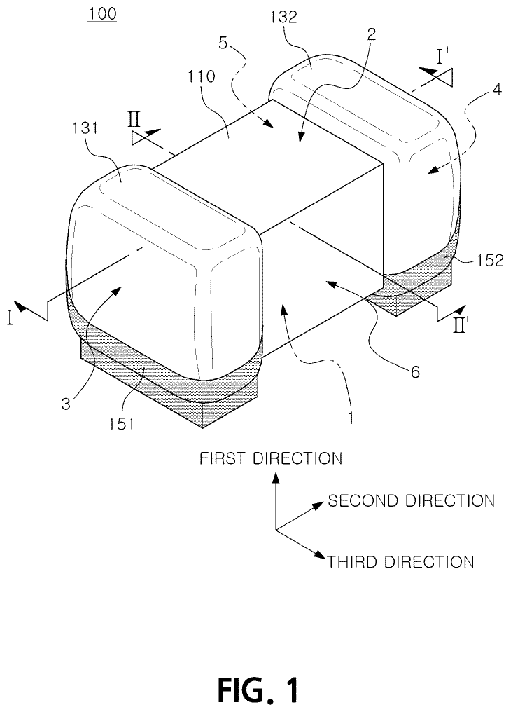

FIG. 1 is a perspective view illustrating a multilayer electronic component 100 according to an embodiment of the present disclosure.

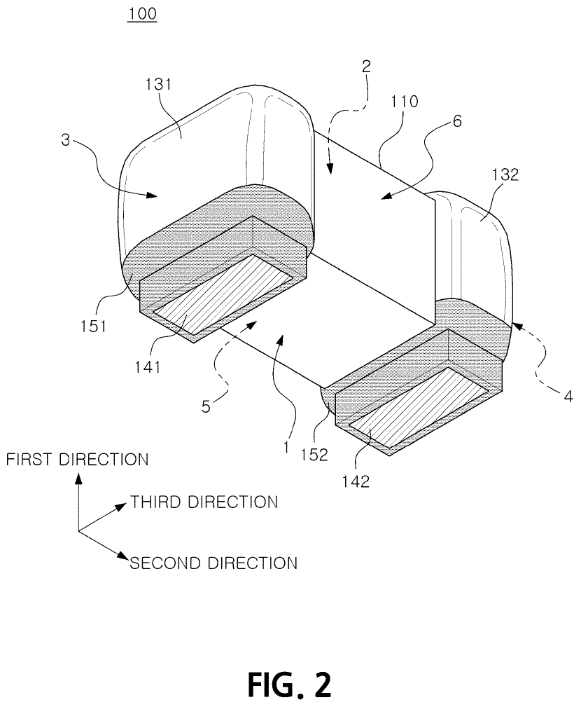

FIG. 2 is a bottom perspective view of the multilayer electronic component according to FIG. 1.

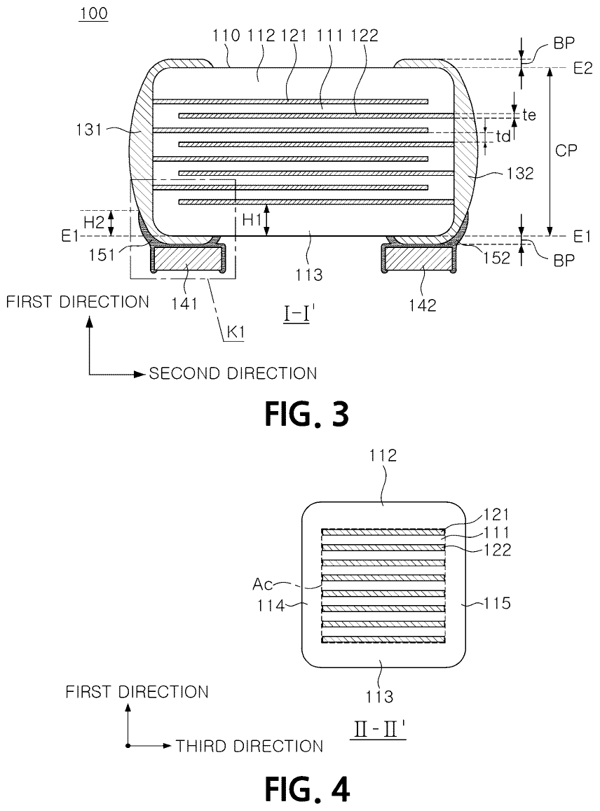

FIG. 3 is a cross-sectional view taken along line I-I′ of FIG. 1.

FIG. 4 is a cross-sectional view taken along line II-II′ of FIG. 1.

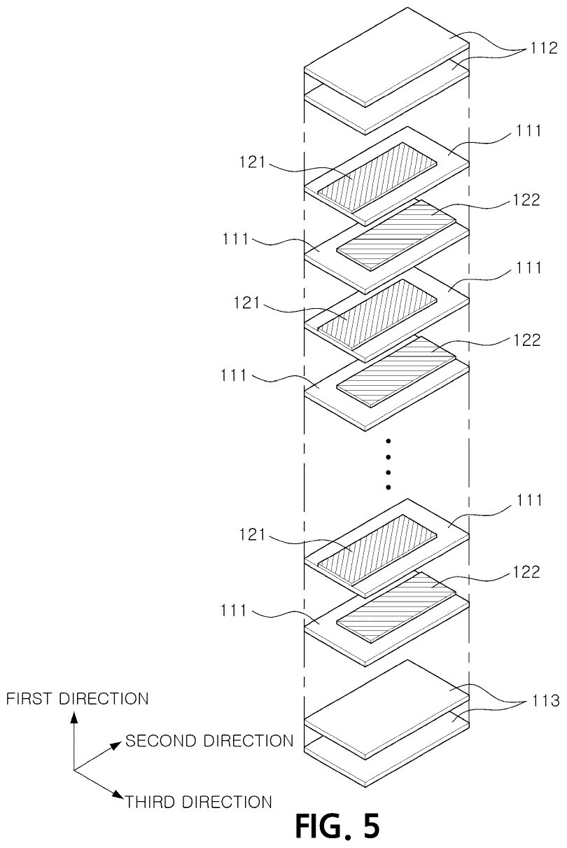

FIG. 5 is an exploded perspective view illustrating a body of a multilayer electronic component according to an embodiment of the present disclosure.

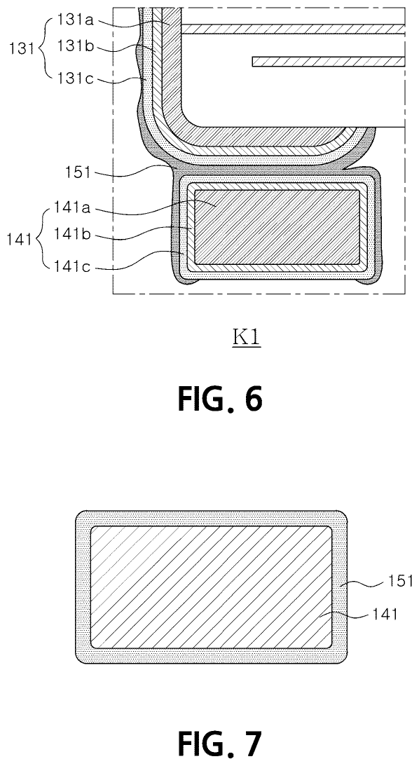

FIG. 6 is an enlarged view of region K1 of FIG. 3.

Hereinafter, a multilayer electronic component 100 according to an embodiment of the present disclosure will be described in detail, with reference to FIGS. 1 to 6.

According to an embodiment of the present disclosure, a multilayer electronic component 100 may include: a body 110 including a dielectric layer 111 and internal electrodes 121 and 122 disposed alternately with the dielectric layer 111 in a first direction, the body having first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first to fourth surfaces and opposing each other in a third direction; external electrodes 131 and 132 including a connection portion CP disposed on the third and fourth surfaces and a band portion BP extended from the connection portion to a portion of the first surface; bump electrodes 141 and 142 disposed on the band portion of the external electrode; and a solder layer 151 and 152 comprising a Sn-based solder including one or more of Sb, Ag, and Cu, disposed between the band portion of the external electrode and the bump electrode, and extending to the cross-section in second direction of the bump electrode and the connection portion of the external electrode.

The body 110 may have a dielectric layer 111 and internal electrodes 121 and 122, alternately stacked therein.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may contract in a process in which the body is sintered. However, the body 110 may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

In an embodiment, the body 110 may include a 1-3 corner connecting the first surface and the third surface, a 1-4 corner connecting the first surface and the fourth surface, a 2-3 corner connecting the second surface and the third surface, and a 2-4 corner connecting the second surface and the fourth surface, wherein the 1-3 corner and the 2-3 corner may have a form contracting toward center of the body in the first direction toward the third surface, and the 1-4 corner and the 2-4 corner may have a form contracting toward center of the body in the first direction toward the fourth surface.

As the margin region where the internal electrodes 121 and 122 are not disposed on the dielectric layer 111, overlaps, a step difference may occur due to the thickness of the internal electrodes 121 and 122, the corner connecting the first surface and the third to fifth surfaces and/or the corner connecting the second surface and the third to fifth surfaces may have a contracted form toward the center of the body 110 in the first direction when viewed based on the first surface or the second surface. Alternatively, due to the contraction behavior during the sintering process of the body, a corner connecting the first surface 1 and the third to sixth surfaces 3,4,5,6 and/or a corner connecting the second surface 2 and the third to sixth surfaces 3,4,5,6 may have a form contracting toward the center of the body 110 in the first direction when viewed with based on the first surface or the second surface. Alternatively, to prevent chipping defects, or like, the corners connecting each surface of the body 110 may be rounded by performing an additional process, in which the corners connecting the first surface and the third to sixth surfaces and/or the corners connecting the second surface and the third to sixth surfaces may have a rounded form.

The corners may include the 1-3 corner connecting the first surface and the third surface, the 1-4 corner connecting the first surface and the fourth surface, the 2-3 corner connecting the second surface and the third surface, and the 2-4 corner connecting the second surface and the fourth surface. Additionally, the corners may include a 1-5 corner connecting the first surface and the fifth surface, a 1-6 corner connecting the first surface and the sixth surface, a 2-5 corner connecting the second surface and the fifth surface, and a 2-6 corner connecting the second surface and the sixth surface. The first to sixth surfaces of the body 110 may be generally flat surfaces, and the non-flat regions may be considered to be corners. Hereinafter, an extension line of each surface may refer a line extended based on the flat portion of each surface.

Meanwhile, in order to suppress the step difference caused by the internal electrodes 121 and 122, after stacking, the internal electrodes are cut so that they are exposed to the fifth and sixth surfaces 5 and 6 of the body, and then when a single dielectric layer or two or more dielectric layers are stacked in the third direction (width direction) on both surfaces of the capacitance formation portion Ac to form the margin portions 114 and 115, the portion connecting the first surface and the fifth and sixth surfaces and the portion connecting the second surface and the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without a scanning electron microscope (SEM).

According to an embodiment of the present disclosure, a raw material for forming the dielectric layer 111 is not particularly limited, as long as sufficient electrostatic capacitance may be obtained therewith. For example, a barium titanate-based material, a lead composite perovskite-based material, or a strontium titanate-based material, may be used. The barium titanate-based material may include BaTiO₃-based ceramic powder, and the ceramic powder may be, for example, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium (Ca), zirconium (Zr), or the like, are partially dissolved in BaTiO₃, and the like.

A material for forming the dielectric layer 111 may include various ceramic additives, organic solvents, binders, dispersants, and the like, added to powder particles such as barium titanate (BaTiO₃) powder particles, or the like, according to an object of the present disclosure.

The body 110 may include a capacitance formation portion Ac, in which capacitance is formed by a first internal electrode 121 and a second internal electrode 122 alternately disposed to face each other with the dielectric layer 111 interposed therebetween, and cover portions 112 and 113 formed upper and lower portions of the capacitance formation portion Ac in the first direction.

In addition, the capacitance formation portion Ac is a portion contributing to capacitance formation of a capacitor, and may be formed by repeatedly stacking a plurality of first and second internal electrodes 121 and 122 with a dielectric layer 111 interposed therebetween.

The cover portions 112 and 113 may include an upper cover portion 112 disposed on an upper portion of the capacitance formation portion Ac in the first direction and a lower cover portion 113 disposed on a lower portion of the capacitance formation portion Ac in the first direction.

The upper cover portion 112 and the lower cover portion 113 may be formed by stacking a single dielectric layer or two or more dielectric layers on upper and lower surfaces of the capacitance formation portion Ac in a thickness direction, respectively, and the upper cover portion 112 and the lower cover portion 113 may contribute to basically prevent damage to the internal electrodes due to physical or chemical stress.

The upper cover portion 112 and the lower cover portion 113 may not include the internal electrodes, and may include the same material as that of the dielectric layer 111.

That is, the upper cover portion 112 and the lower cover portion 113 may include a ceramic material, for example, a barium titanate (BaTiO₃)-based ceramic material.

In addition, margin portions 114 and 115 may be disposed on a side surface of the capacitance formation portion Ac.

The margin portions 114 and 115 may include a first margin portion 114 disposed on the fifth surface 5 of the body 110 and a second margin portion 115 disposed on the sixth surface 6 thereof. That is, the margin portions 114 and 115 may be disposed on both end surfaces of the body 110 in a width direction.

As illustrated in FIG. 4, the margin portions 114 and 115 may refer to a region between the two ends of the first and second internal electrodes 121 and 122 and a boundary surface of the body 110 in a cross-section of the body 110 in the width-thickness (W-T) direction.

The margin portions 114 and 115 may basically contribute to prevent damage to the internal electrodes due to physical or chemical stresses.

The margin portions 114 and 115 may be formed by forming an internal electrode by applying a conductive paste to a ceramic green sheet, except for the region where the margin portion is to be formed.

In addition, to suppress a step difference caused by the internal electrodes 121 and 122, after stacking, the internal electrodes may be cut so that they are exposed to the fifth and sixth surfaces 5 and 6 of the body, and then a single dielectric layer or two or more dielectric layers may be stacked in the third direction (width direction) on both surfaces of the capacitance formation portion Ac to form the margin portions 114 and 115.

The internal electrodes 121 and 122 may be alternately stacked with the dielectric layer 111.

The internal electrodes 121 and 122 may include first and second internal electrodes 121 and 122. The first and second internal electrodes 121 and 122 are alternately disposed to oppose each other with the dielectric layer 111 forming the body 110 interposed therebetween, and may be exposed to the third and fourth surfaces 3 and 4 of the body 110, respectively.

Referring to FIG. 3, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

That is, the first internal electrode 121 may be connected to the first external electrode 131 and may not be connected to the second external electrode 132, and the second internal electrode 122 may be connected to the second external electrode 132 and may not be connected to the first external electrode 131. Accordingly, the first internal electrode 121 may be formed at a certain distance from the fourth surface 4, and the second internal electrode 122 may be formed at a certain distance from the third surface 3.

In this case, the first and second internal electrodes 121 and 122 may be electrically separated from each other by a dielectric layer 111 disposed in the middle.

The body 110 may be formed by alternately stacking ceramic green sheets printed with the first internal electrode 121 and ceramic green sheets printed with the second internal electrode 122, followed by firing.

The material forming the internal electrodes 121 and 122 is not particularly limited, and any material having excellent electrical conductivity may be used.

For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Additionally, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti) and alloys thereof on a ceramic green sheet. A printing method for the conductive paste for internal electrodes may use a screen printing method or a gravure printing method, but the present disclosure is not limited thereto.

The external electrodes 131 and 132 may include the connection portion CP disposed on the third and fourth surfaces and a band portion BP extended from the connection portion to a portion of the first surface. Referring to FIG. 3, a region disposed between an extension line E1 of the first surface and an extension line E2 of the second surface among the external electrodes 131 and 132 may be referred to as a connection portion CP, and a region disposed below the extension line E1 of the first surface may be referred to as a band portion BP.

Meanwhile, the band portion BP may not be limited to being disposed on the first surface, and may be disposed to extend from the connection portion to one or more of the second, fifth, and sixth surfaces.

The external electrodes 131 and 132 may include the first external electrode 131 and the second external electrode 132. The first external electrode 131 may be disposed on the third surface and connected to the first internal electrode 121, and the second external electrode 132 may be disposed on the fourth surface and connected to the second internal electrode 122.

Bump electrodes 141 and 142 may be disposed on the band portion BP of the external electrode. The bump electrodes 141 and 142 may contribute to reducing or absorbing vibrations transmitted from the substrate to the multilayer electronic components, and may contribute to suppressing acoustic noise.

The bump electrodes 141 and 142 may include a first bump electrode 141 and a second bump electrode 142. The first bump electrode 141 may be disposed on the band portion of the first external electrode 131 and may be electrically connected to the first external electrode 131, and the second bump electrode 142 may be disposed on the band portion of the second external electrode 132 and electrically connected to the second external electrode 132.

Solder layers 151 and 152 may contribute to bond the external electrodes 131 and 132 and the bump electrodes 141 and 142. In addition, solder layers 151 and 152 may contribute to preventing the Sn plating layers 131c and 132c and/or bump Sn plating layers 141c and 142c from flowing down when fixing the multilayer electronic component to a substrate by using general solder.

The solder layers 151 and 152 may include a Sn-based solder including one or more of Sb, Ag, and Cu. As the Sn-based solder contains one or more of Sb, Ag, and Cu, the melting point may be 200° C. or higher, and when the multilayer electronic component is fixed to the substrate by using general solder, the solder layers 151 and 152 may not melt, so it may contribute to maintaining the bond between the external electrodes 131 and 132 and the bump electrodes 141 and 142.

According to an embodiment of the present disclosure, the Sn-based solder may be one or more of Sn-Sb solder, Sn-Ag solder, Sn-Cu solder, and Sn-Ag-Cu solder.

Meanwhile, the contents of Sb, Ag, and Cu included in the Sn-based solder may not be particularly limited, and may be appropriately added depending on the intended use and environment.

For example, in the case of Sn-Ag solder, a high-melting-point solder having a melting point of approximately 221° C. may be used when the Sn content to 96.5 wt %, and the Ag content to 3.5 wt %, and in the case of Sn-Cu solder, a high-melting-point solder having a melting point of approximately 227° C. may be used when the Sn content to 99.3 wt % and the Cu content to 0.7 wt %.

The solder layers 151 and 152 may be disposed between the band portion BP of the external electrodes 131 and 132 and the bump electrodes 141 and 142, and may extend to a cross-section of the bump electrodes 141 and 142 in the second direction and the connection portion CP of the external electrodes 131 and 132. According to an embodiment of the present disclosure, as a cross-section of the bump electrodes 141 and 142 in the second direction extends to the connection portion CP of the external electrodes 131 and 132, it may prevent the Sn plating layers 131c and 132c and/or the bump Sn plating layers 141c and 142c from flowing down when the multilayer electronic component is fixed to the substrate using general solder. In addition, the external electrodes 131 and 132 and the bump electrodes 141 and 142 may be more firmly joined, and the hermetic sealing of the multilayer electronic component 100 may be strengthened.

When the solder layers 151 and 152 are disposed only between the band portion BP of the external electrodes 131 and 132 and the bump electrodes 141 and 142, there is a concern of mounting defects occurring due to the Sn plating layers 131c and 132c and/or the bump Sn plating layers 141c and 142c not being prevented from flowing down when the multilayer electronic component is fixed to the substrate by using general solder.

In an embodiment, the end of the solder layers 151 and 152 disposed on the connection portion may be disposed between the extension line E1 of the first surface and the extension line E2 of the second surface. That is, the solder layers 151 and 152 may not need to cover the entire connection portion CP of the external electrode, and even if it covers only a portion, the external electrodes 131 and 132 and the bump electrodes 141 and 142 may be firmly connected while preventing the Sn plating layer from flowing down.

In an embodiment, the following relationship may be satisfied: H1<H2<T/2 where an average distance from the first surface to an internal electrode disposed closest to the first surface in the first direction is H1, an average distance from an extension of the first surface to an end of a solder layer disposed on the connection portion in the first direction is H2, and a size of the body in the first direction is T.

In order for H2 to form a solder layer of T/2 or more, improving an effect of firmly bonding the external electrodes 131 and 132 and the bump electrodes 141 and 142 while preventing the Sn plating layer from flowing down, may be insufficient compared to a required amount of solder.

By satisfying the condition H1<H2, the effect of firmly bonding the external electrodes 131 and 132 and the bump electrodes 141 and 142 while preventing the Sn plating layer from flowing downward, may be more reliably secured.

However, it is not intended to exclude the case in which H2 is lower than H1, and even when H2 is lower than H1, the effect of firmly bonding the external electrodes 131 and 132 and the bump electrodes 141 and 142 while preventing the Sn plating layer from flowing down, may be secured, so that H1≥H2 may be satisfied according to an embodiment of the present disclosure.

H1 and H2 may be an average value measured from a cross-section (L-T cross-section) cut in the first and second directions from the central portion of the body 110 in the third direction. H1 may be an average value of distances between the internal electrode disposed closest to the first surface 1 in the cross-section and the first surface 1 measured at a certain point in the second direction, and H2 may be a value measured based on the end of the solder layer disposed at the connection portion, and may be an average value of a value measured from the first external electrode 131 side and a value measured from the second external electrode 132 side. In this case, the extension line E1 of the first surface contributing as a reference for measuring H1 and H2, may be the same.

In addition, a size T of the body 110 in the first direction may likewise be a value of the extension line E1 of the first surface and the extension line E2 of the second surface in the first direction, in the cross-section (L-T cross-section) of the body 110 cut in the first and second directions from the central portion in the third direction.

In an embodiment, a region of the solder layers 151 and 152 extending in cross-section of the bump electrode in the second direction may be disposed to cover at 50 areas or more of an area of cross-section of the bump electrode in the second direction. Accordingly, an effect of firmly bonding the external electrodes 131 and 132 and the bump electrodes 141 and 142 while preventing the Sn plating layer from flowing down, may be more reliably secured.

Meanwhile, the solder layers 151 and 152 may extend to a lower surface of the bump electrode in the first direction, but in case the solder layers 151 and 152 extends to the lower surface of the bump electrode in the first direction, when the multilayer electronic component is fixed to the substrate using general solder, it may be difficult to secure bonding strength between the multilayer electronic component and the substrate, as the solder layers 151 and 152 may not dissolve well in general solder, and a mounting defect may occur.

Therefore, in an embodiment, the solder layers 151 and 152 may be disposed to extend to a portion of the lower surface of the bump electrode in the first direction.

Referring to FIG. 7, which schematically illustrates the lower surface of the bump electrode, more preferably, a region covered by the solder layer 151 of the lower surfaces of the bump electrode 141 in the first direction may be 10 area % or less. Accordingly, the external electrodes 131 and 132 and the bump electrodes 141 and 142 may be firmly bonded while preventing the Sn plating layer from flowing down, and the bonding strength between the multilayer electronic component and the substrate may also be reliably secured.

That is, it is desirable to have a minimum solder layer on the lower surface of the bump electrode, which comes into contact with the substrate, and more preferably, solder layer may not be disposed on the lower surface.

The method for controlling the arrangement of the solder layers 151 and 152 may not be particularly limited, and in the process of heat-treating to bond the external electrodes 131 and 132 and the bump electrodes 141 and 142 by using the solder layers 151 and 152, the arrangement of the solder layers 151 and 152 may be controlled by controlling the degree of diffusion of the solder layers 151 and 152 by adjusting the heat treatment temperature, the material and amount of the solder layers, or the like. In addition, by attaching a high-heat-resistant adhesive film to the bottom surface of the bump electrodes (141, 142) for masking before heat treatment, the molten solder layers 151 and 152 may be more reliably prevented from penetrating into the lower surface of the bump electrode 141 and 142. The high heat-resistant adhesive film attached to the lower surface of the bump electrodes 141 and 142 after heat treatment, may be removed.

Meanwhile, at least a portion of the solder layers may be disposed in an island form.

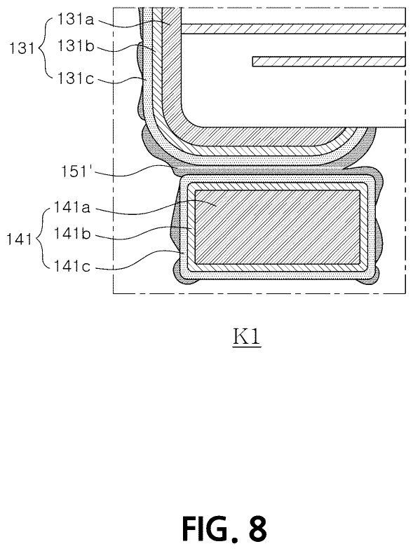

Referring to FIG. 8, which is an enlarged view of the region K1 of FIG. 3 according to another embodiment, a solder layer 151 may not be disposed continuously, but may be disposed in an island form having a region interrupted in the middle.

However, in order to firmly connect the external electrodes 131 and 132 and the bump electrodes 141 and 142, it may be desirable for the region of the solder layer 151 between the band portion of the external electrode and the bump electrode to be disposed in a layered form.

Meanwhile, the external electrodes 131 and 132 may be formed of any material as long as they have electrical conductivity, such as a metal, and specific materials may be determined by consideration of electrical characteristics, structural stability, or the like, and further may have a multilayer structure.

For example, the external electrodes 131 and 132 may include electrode layers 131a and 132a disposed on the body 110 and plating layers 131b, 132b, 131c, and 132c formed on the electrode layers.

For a more specific example of the electrode layers 131a and 132a, the electrode layers may be firing electrodes including a conductive metal and a glass, or resin-based electrode including a conductive metal and a resin.

In addition, the electrode layers 131a and 132a may have a form in which the fired electrode and the resin-based electrode are sequentially formed on the body. Additionally, the electrode layers may be formed by transferring a sheet including the conductive metal on the body, or may be formed by transferring the sheet including the conductive metal to the fired electrode.

A material having excellent electrical conductivity may be used as the conductive metal included in the electrode layers 131a and 132a, but is not particularly limited thereto. For example, the conductive metal may be one or more of nickel (Ni), copper (Cu), and alloys thereof.

The plating layers 131b, 132b, 131c, and 132c may contribute to improve mounting characteristics. A type of the plating layers 131b, 132b, 131c, and 132c are not particularly limited, may be plating layers including one or more of Ni, Sn, Pd, and alloys thereof, and may be formed as a plurality of layers.

In an embodiment, the external electrodes 131 and 132 may be connected to the internal electrodes 121 and 122 and may include the electrode layers 131a and 132a including Cu and a glass, a Ni plating layers 131b and 132b disposed on the electrode layers, and a Sn plating layers 131c and 132c disposed on the Ni plating layer.

The bump electrodes 141 and 142 may be formed using any material that has electrical conductivity, such as metal, and specific materials may be determined by consideration of electrical characteristics, structural stability, or the like, and further may have a multilayer structure.

For example, the bump electrodes 141 and 142 may include bump core portions 141a and 142a disposed at the center of the bump electrodes, and bump plating layers 141b, 142b, 141c, and 142c disposed on the bump core portion.

In an embodiment, the bump electrodes 141 and 142 may include the bump core portions 141a and 142a disposed at the center of the bump electrode and including Cu, bump Ni plating layers 141b and 142b disposed on the bump core portion, and bump Sn plating layers 141c and 142c disposed on the bump Ni plating layers.

In an embodiment, the solder layers 151 and 152 may be disposed to be in contact with the Sn plating layer 131c and 132c and the bump Sn plating layers 141c and 142c.

As one of the many effects of the present disclosure is to improve the reliability of multilayer electronic components by controlling the arrangement of the solder layers connecting the bump electrodes and band portions.

As one of the many effects of the present disclosure, suppressing an occurrence of mounting defects when mounting a multilayer electronic component on a substrate.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While example embodiments have been shown and described above, it will be apparent to those skilled in the art that modifications and variations could be made without departing from the scope of the present invention as defined by the appended claims.

What is claimed is:

1. A multilayer electronic component, comprising:
a body including a dielectric layer and internal electrodes alternately disposed with the dielectric layer in a first direction, and including first and second surfaces opposing each other in the first direction, third and fourth surfaces connected to the first and second surfaces and opposing each other in a second direction, and fifth and sixth surfaces connected to the first to fourth surfaces and opposing each other in a third direction;
an external electrode including a connecting portion disposed on the third and fourth surfaces and a band portion extending from the connecting portion to a portion of the first surface;
a bump electrode disposed on a band portion of the external electrode; and
wherein a solder layer comprises a Sn-based solder containing one or more of Sb, Ag, and Cu, disposed between the band portion of the external electrode and the bump electrode, and extending to a cross-section in the second direction of the bump electrode and the connection portion of the external electrode.

2. The multilayer electronic component of claim 1, wherein the Sn-based solder is selected from a group consisting of Sn-Sb-based solder, Sn-Ag-based solder, Sn-Cu-based solder, and Sn-Ag-Cu-based solder.

3. The multilayer electronic component of claim 1, wherein an end of the solder layer disposed on the connection portion is disposed between an extension line of the first surface and an extension line of the second surface.

4. The multilayer electronic component of claim 1, satisfying H1<H2<T/2, where H1 is an average distance from the first surface to the internal electrode closest to the first surface in the first direction, H2 is an average distance from an extension line of the first surface to an end of the solder layer disposed on the connection portion in the first direction, and T is a size of the body in the first direction.

5. The multilayer electronic component of claim 1, satisfying H1≥H2, where H1 is an average distance from the first surface to the internal electrode closest to the first surface in the first direction,
where H2 is an average distance from an extension line of the first surface to an end of the solder layer disposed on the connection portion in the first direction.

6. The multilayer electronic component of claim 1, wherein a region of the solder layer extending to cross-section of the bump electrode in the second direction, is disposed to cover 50% or more of a region of a cross-sectional area of the bump electrode in the second direction.

7. The multilayer electronic component of claim 1, wherein the solder layer extends to a portion of a lower surface of the bump electrode in the first direction.

8. The multilayer electronic component of claim 7, wherein a region covered by the solder layer of the bump electrode in the first direction is 10% or less of an area of a region thereof.

9. The multilayer electronic component of claim 1, where at least a portion of the solder layer is arranged in an island shape.

10. The multilayer electronic component of claim 9, wherein a region disposed between the band portion of the external electrode and the bump electrode of the solder layers is disposed in a layer form.

11. The multilayer electronic component of claim 1, wherein the external electrode includes an electrode layer connected to the internal electrode and contains Cu and glass, a Ni plating layer disposed on the electrode layer, and a Sn plating layer disposed on the Ni plating layer.

12. The multilayer electronic component of claim 11, wherein the bump electrode includes a bump core portion containing Cu and disposed at a center of the bump electrode, a bump Ni plating layer disposed on the bump core portion, and a bump Sn plating layer disposed on the bump Ni plating layer.

13. The multilayer electronic component of claim 12, wherein the solder layer is disposed to be in contact with the Sn plating layer and the bump Sn plating layer.

14. The multilayer electronic component of claim 1, wherein the solder layer comprises the Sn-based solder having a melting point of 200° C. or higher.
